(19) United States
(12) Patent Application Publication
(10) Pub. No.: US 2023/0417288 A1
(43) Pub. Date: Dec. 28, 2023

(54) KEY FOR ROTATIONAL COUPLING

(71) Applicant: U.S. Tsubaki Power Transmission, LLC, Wheeling, IL (US)

(72) Inventors: Bryan Brickey, Buffalo Grove, IL (US); Keisuke Miyake, Tsuyama (JP); Takayuki Nishi, Wheeling, IL (US); Ryosuke Tani, Tsuyama (JP)

(21) Appl. No.: 17/846,442

(22) Filed: Jun. 22, 2022

(51) Int. Cl. F16D 1/08

(52) U.S. Cl. CPC F16D 1/0876

(57) ABSTRACT

Embodiments of a coupling system to couple a rotating clutch portion with a shaft include a sleeve and at least one key. The sleeve is positioned between the rotating clutch portion and the shaft. The sleeve has at least one key slot to receive the at least one key. The rotating clutch portion includes a key slot to receive one of the at least one keys. The shaft includes a key slot to receive one of the at least one keys. When the at least one keys is received by the various key slots, the rotating clutch portion is rotationally coupled to the shaft.

### CROSS REFERENCE TO RELATED APPLICATIONS

Not applicable.

### BACKGROUND

Generally, this application relates to clutches, such as cam clutches, and systems for coupling a shaft with a clutch. Clutches can be used to prevent reverse rotation of rollers or shafts which may cause damage to machinery and expensive equipment. For example, a clutch can be used to prevent reverse rotation of a shaft (e.g., pulley shaft) of a sloping conveyor, a bucket elevator, or the like. In order for a given clutch to operate with the intended effect, it is necessary to couple the clutch with the shaft.

### SUMMARY

According to embodiments, a key is disclosed for use in a system with a shaft, a clutch, and a sleeve, the shaft has a shaft key slot, the clutch includes a rotating clutch portion having a rotating clutch portion key slot, and the sleeve has as sleeve key slot. The key comprises an elongated body including an outer region, an inner region, and a transition region between the outer region and the inner region, the outer region comprises a width and is sized to be received by the sleeve key slot, the inner region comprises a width and is sized to be received by the shaft key slot such that the sleeve and the shaft are rotationally coupled with each other, the width of the inner region is smaller than the width of the outer region, and the transition region includes a varying width such that a width of a portion of the transition region proximate the outer region is greater than a width of a portion of the transition region proximate the inner region. The outer region may be received by the rotating clutch portion key slot, such that the shaft, the rotating clutch portion, and the sleeve are rotationally coupled to each other. The varying width of the transition region may be defined at least in part by a radius (e.g., between approximately 0.016″ and 0.2″, such as approximately 0.12″). The varying width of the transition region may be defined at least in part by a first radius on a first side and a second radius on a second side. One or both of these radii may be between approximately 0.016″ and such as approximately 0.12″. The key may include or be formed with a material such as non-hardened steel.

According to embodiments, a coupling system for coupling a rotating clutch portion of a clutch with a shaft is disclosed. The rotating clutch portion has a rotating clutch portion key slot and the shaft has a shaft key slot. The coupling system comprises: a sleeve having a wall and a sleeve key slot through the wall, the sleeve is configured to be received by the rotating clutch portion, and the sleeve is configured to receive the shaft; and a key having a height, the key includes an outer region, an inner region, and a transition region between the outer region and the inner region, the outer region comprises a width and is sized to be received by the rotating clutch portion key slot, the inner region comprises a width and is sized to be received by the shaft key slot, the width of the inner region is smaller than the width of the outer region, and the transition region includes a varying width such that a width of a portion of the transition region proximate the outer region is greater than a width of a portion of the transition region proximate the inner region. The key is configured to be simultaneously received by the shaft key slot, the sleeve key slot, and the rotating clutch portion key slot such that the shaft and the sleeve are rotationally coupled. The transition region may not be configured to be received by the shaft key slot. The transition region may be configured to only be received by the sleeve key slot. The key may include or be formed of non-hardened steel. The length of the key and the length of the sleeve may be approximately the same. The varying width of the transition region may be defined at least in part by a first radius on a first side and a second radius on a second side, the first radius is between approximately 0.016″ and 0.2″, such as approximately and the second radius is between approximately 0.016″ and 0.2″, such as approximately The sleeve key slot may extend through the thickness of the sleeve, the outer region of the key may further be configured to be received by the rotating clutch portion key slot, and the height of the key may be greater than the thickness of the sleeve, such that the key is configured to be simultaneously received by the rotating clutch portion key slot, the shaft key slot, and the sleeve key slot, such that the shaft, sleeve, and rotating clutch portion are rotationally coupled to each other. The sleeve key slot may only extend across a portion of the length of the sleeve. The sleeve key slot may not extend to either end of the sleeve. The coupling system may further comprise a second key, the sleeve has a second sleeve key slot, and the second key is configured to be received by the rotating clutch portion key slot and the second sleeve key slot such that the sleeve and the rotating clutch portion are rotationally coupled to each other. The sleeve key slot may not extend through the thickness of the sleeve, and the second sleeve key slot may not extend through the thickness of the sleeve.

According to embodiments, a coupling system for coupling a rotating clutch portion of a clutch with a shaft is disclosed, the rotating clutch portion has a rotating clutch portion key slot, the shaft has a shaft key slot, and the coupling system comprises a sleeve, a first key, and a second key. The sleeve includes a wall having an outer surface and an inner surface, the sleeve includes a first key slot in the outer surface of the wall, the sleeve includes a second key slot in the inner surface of the wall, the sleeve is configured to be received by the rotating clutch portion, and the sleeve is configured to receive the shaft. The first key is configured to be received by the rotating clutch portion key slot and the first key slot of the sleeve, such that the rotating clutch portion and the sleeve are rotationally coupled. The second key is configured to be received by the shaft key slot and the second key slot of the sleeve, such that the shaft and the sleeve are rotationally coupled. The first key may be wider than the second key, and the first key slot of the sleeve may be wider than the second key slot of the sleeve. The first key slot of the sleeve may define a first centerline, the second key slot of the sleeve may define a second centerline, and the first centerline and the second centerline may be offset by 180 degrees around the sleeve.

### BRIEF DESCRIPTION OF SEVERAL VIEWS OF THE DRAWINGS

FIG. 1A is a perspective view a clutch and a shaft.

FIG. 1B is a front view of the clutch and a shaft shown in FIG. 1A.

FIG. 1C is an exploded view the clutch and a shaft shown in FIG. 1A.

FIG. 2A is a perspective view a clutch, a shaft, a sleeve, and a key, according to a first arrangement.

FIG. 2B is a front view of the system shown in FIG. 2A.

FIG. 2C is an exploded view of the system shown in FIG. 2A.

FIG. 3A is a perspective view a clutch, a shaft, a sleeve, and a key, according to a second arrangement.

FIG. 3B is a front view of the system shown in FIG. 3A.

FIG. 3C is an exploded view of the system shown in FIG. 3A.

FIG. 4A is a perspective view a clutch, a shaft, a sleeve, and two keys, according to a third arrangement.

FIG. 4B is a front view of the system shown in FIG. 4A.

FIG. 4C is an exploded view of the system shown in FIG. 4A.

FIGS. 5A-5G are perspective, left-side, right-side, front, back, top, and bottom views, respectively, of a key according to techniques disclosed herein.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

Clutches, such as backstop clutches, may be expensive. Further, shafts, such as pulley shafts, may have a variety of widths. Techniques described herein facilitate providing or adapting backstop clutches for a variety of shafts in an efficient and cost-effective manner.

Rather than customizing a clutch to accommodate a given shaft, a sleeve system is disclosed herein to allow for one clutch design to accommodate multiple shaft widths. Three different arrangements are disclosed herein. However, there is no limitation required herein that any of the arrangements of a sleeve system can only work with shafts within a particular range of widths. For the purposes of this disclosure, any arrangement of a sleeve system can accommodate any shaft, regardless of width.

In addition to the various sleeve system arrangements, key design(s) are disclosed herein that readily accommodate key slots in shafts, where the key slots have varying dimensions.

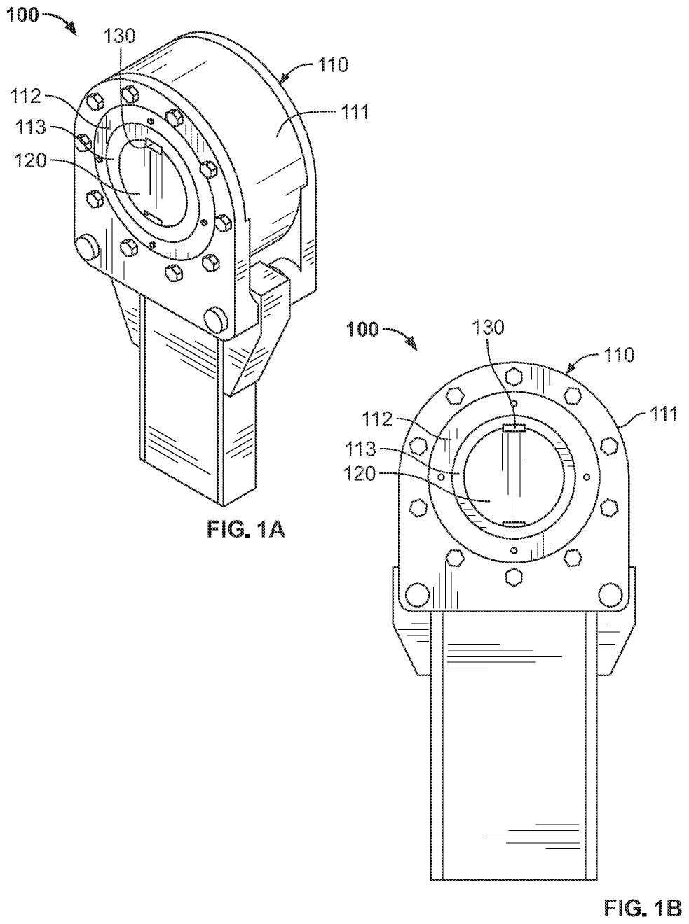

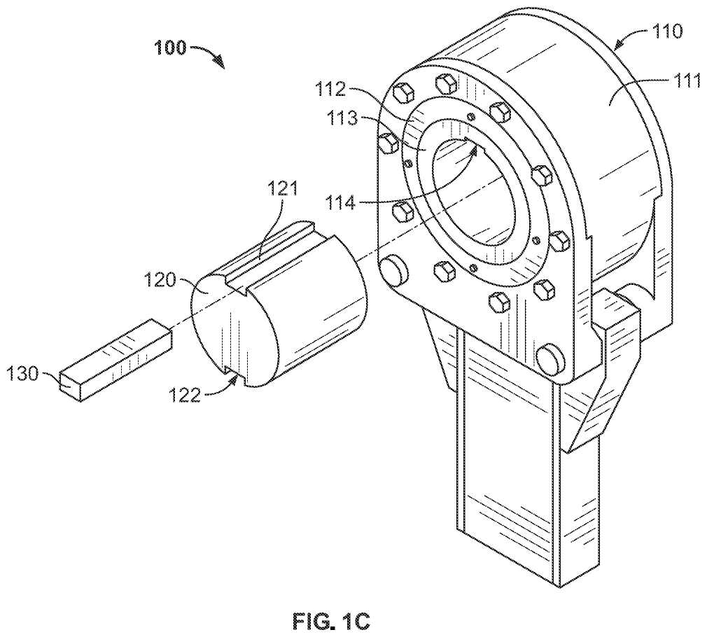

FIGS. 1A-1C show perspective, front, and exploded views, respectively, of a system 100 including a clutch 110, shaft 120, and key 130. Clutch 110 may include body 111, outer race 112, and inner race 113. Outer race 112 may be statically coupled to body 111. Outer race 112 may cooperate with inner race 113, such that inner race 113 selectively rotates with respect to outer race 112 and body 111—e.g., inner race 113 rotates in only one direction. Inner race 113 is an example of a rotating clutch portion.

Inner race 113 includes an inner aperture, which is sized to receive shaft 120. Inner race 113 includes key slot 114. Shaft 120 includes key slot 121 and key slot 122. Key slot 122 may be similar or identical to key slot 121, but on a different part of the shaft 120 (e.g., 180 degrees opposite from key slot 121). Key slot 114 of inner race 113 and key slot 121 of shaft 120 receive different ends of key 130. Key 130 couples inner race 113 and shaft 120, such that they rotate together. When inner race 113 stops rotating, so does shaft 120. In such a way, clutch 110 can prevent undesirable rotation (e.g., reverse rotation) or otherwise control rotation (e.g., determine the direction of permissible rotation) of shaft 120.

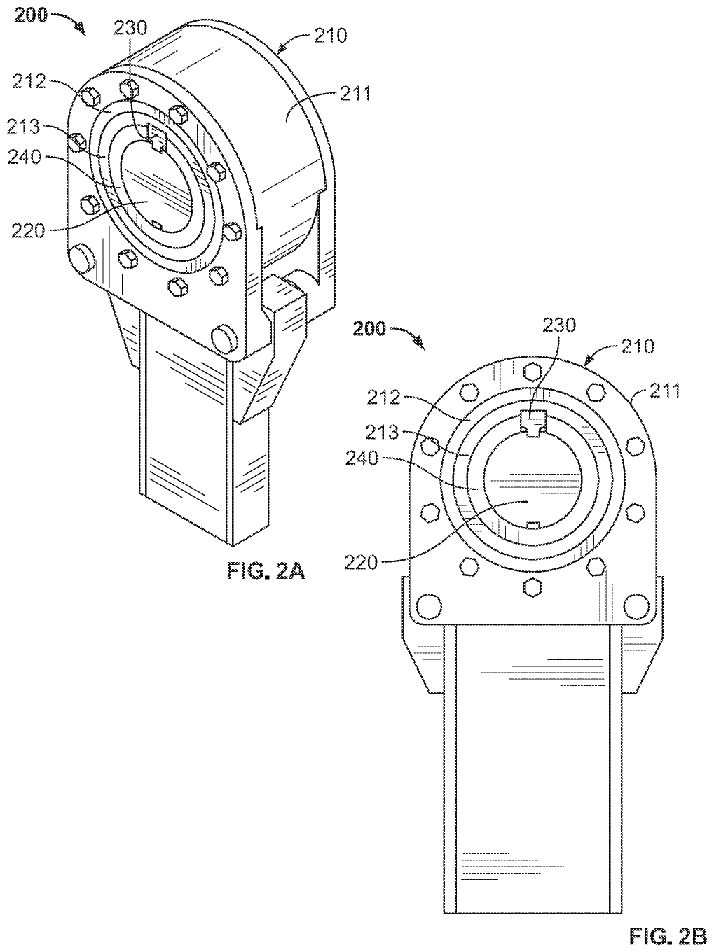

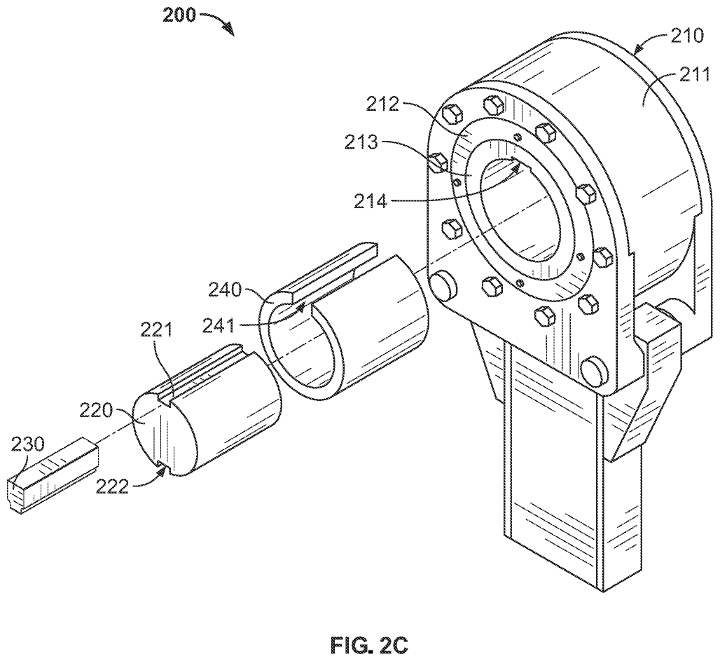

FIGS. 2A-2C show perspective, front, and exploded views, respectively, of system 200 including clutch 210, shaft 220, key 230, and sleeve 240, according to a first arrangement. Clutch 210 may be similar or identical to clutch 110. Clutch 210 includes outer race 212 and inner race 213, which may be similar or identical to outer race 112 and inner race 113, respectively. Inner race 213 may be formed of or include a material such as hardened or non-hardened steel. Inner race 213 includes key slot 214. Outer race 212 may be formed of or include a material such as hardened or non-hardened steel. Shaft 220 may be similar or identical to shaft 120. Shaft 220 may include key slot

221 and key slot 222. Key slots 214 of inner race 213 and key slot 221 of shaft 220 receive different regions of key 230.

The effect of clutch 210 on shaft 220 may be similar or identical to that discussed above in context of FIGS. 1A-1C. Specifically, inner race 213 of clutch 210 may be rotationally coupled to shaft 220. However, unlike the system shown in FIGS. 1A-1C, the system shown in FIGS. 2A-2C adds a sleeve 240 that is interposed between inner race 213 and shaft 220.

Sleeve 240 includes key slot 241. As shown key slot 241 may transverse the entire length of sleeve 240. This may result in sleeve 240 having a “C” shape. Key slot 241 may receive an intermediate region of key 230 (i.e., a region of key 230 between the outer and inner regions, as will be further described). Sleeve 240 may be formed of or include a material such as hardened or non-hardened steel.

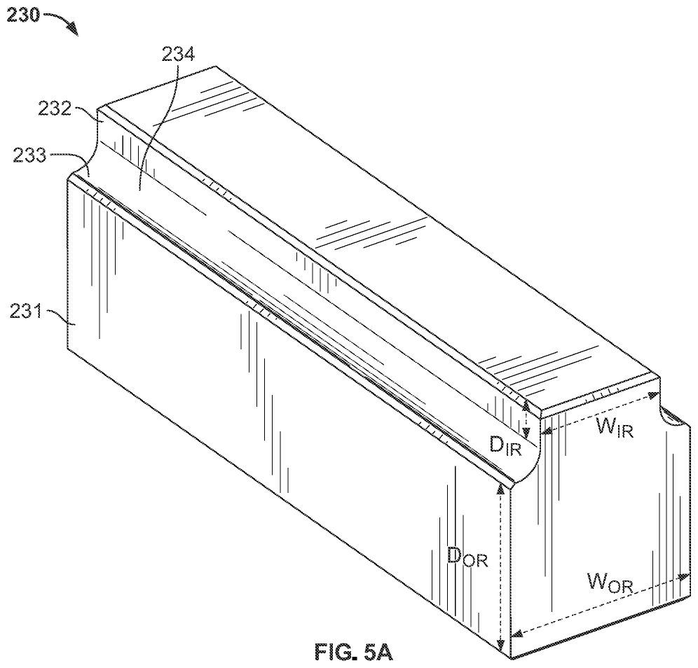

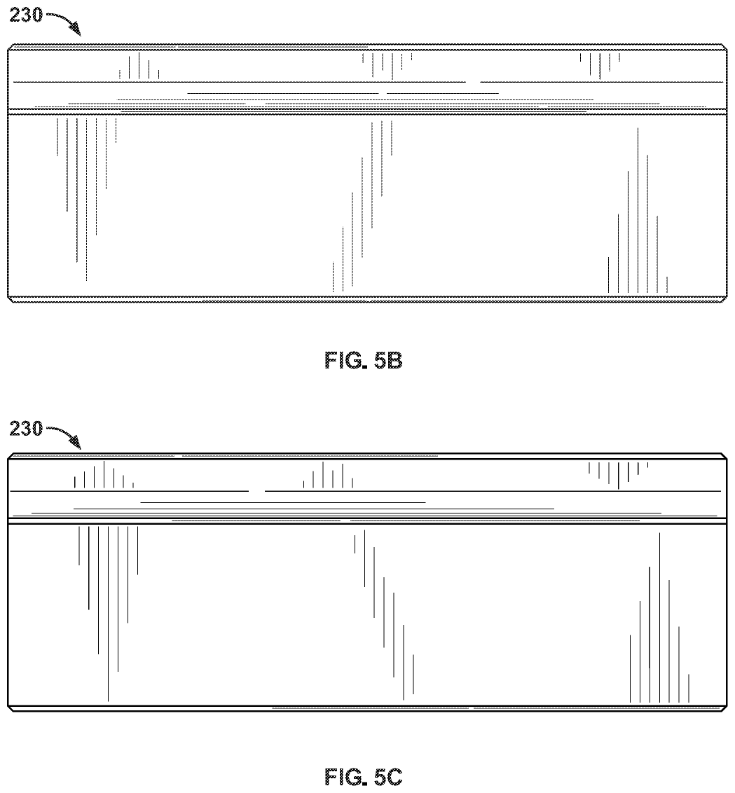

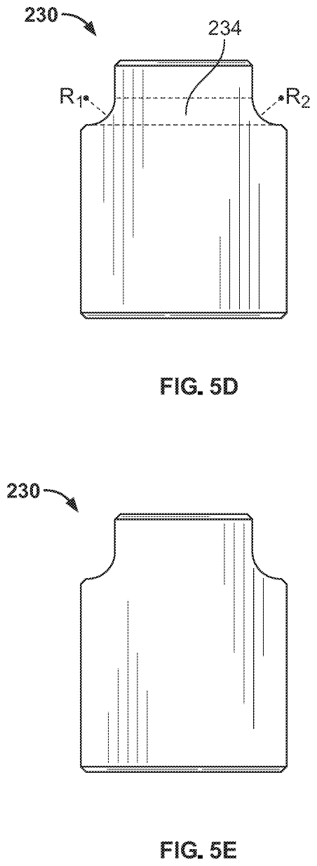

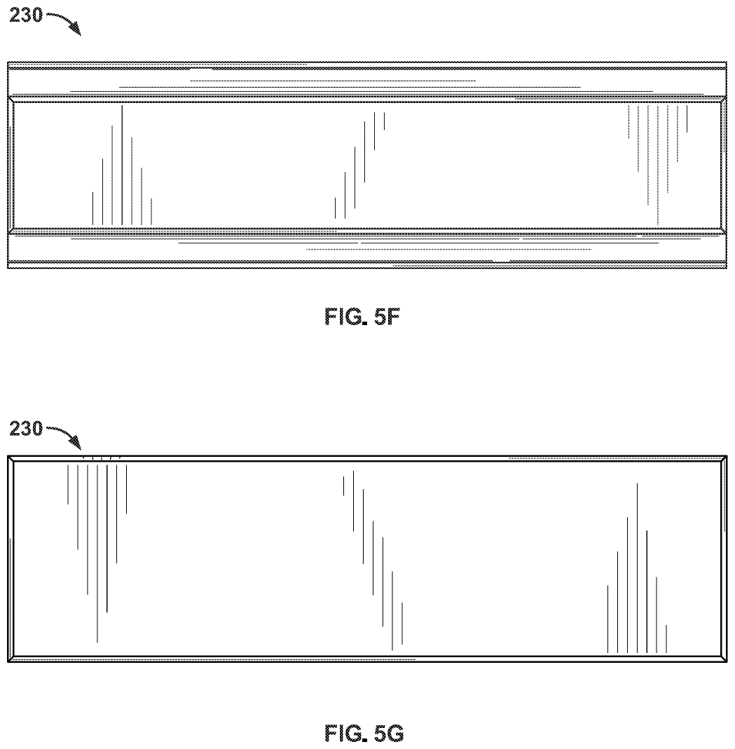

An example of key 230 is depicted in FIGS. 5A-5G, which are perspective, left-side, right-side, front, back, top, and bottom views, respectively, of key 230. Key 230 may be formed of or include a material such as hardened or non-hardened steel. Key 230 may include an elongated body including outer region 231, inner region 232, and intermediate region 233 therebetween. Transition region 234 may be within intermediate region 233. Transition region 234 and intermediate region 233 may be exactly coextensive, although this is not shown in FIGS. 5A-5G.

Outer region 231 may have a width W_{OR} that is sized to be received by key slot 214 of inner race 213. Outer region 231 may also be received by key slot 241 of sleeve 240. Key slot 241 of sleeve 240 may have a width that is substantially equal to the width of key slot 214 of inner race 213. Outer region 231 may have a depth D_{OR} that is equal to or greater than the maximum depth of key slot 214 in inner race 213. Inner region 232 may have a width W_{IR} that is sized to be received by key slot 221 of shaft 220, and inner region 232 may also be received by key slot 241 of sleeve 240. Inner region 232 may have a depth D_{IR} that is equal to or greater than the maximum depth of key slot 221 in shaft 220. When key 230 is received by key slot 214 of inner race 213, key slot 241 of sleeve 240, and key slot 221 of shaft 220, inner race 213, sleeve 240, and shaft 220 are rotationally coupled with each other.

Transition region 234 of key 230 may have a varying width such that width W_{OR} is greater than width W_{IR}. Such a varying width may be defined at least in part by a radius. For example, the varying width of transition region 234 may be defined at least in part by a first radius R₁ on a first side of key 230 and a second radius R₂ on a second side of key 230 (e.g., a side of key 230 opposing the first side). First radius R₁ and/or second radius R₂ may be between approximately 0.016″ and 0.2″, such as approximately 0.12″. First radius R₁ and second radius R₂ may have substantially the same value, as shown. Testing has shown that a radius between approximately 0.016″ and 0.2″, such as approximately 0.12″, improves the durability and expected life of key 230.

Some or all of transition region 234 of key 230 may be received by key slot 241 of sleeve 240. This may result in empty space within key slot 241 of sleeve 240—i.e., space not filled by key 230. At least a portion of transition region 234 may be received by key slot 214 of inner race 213. Alternatively, none of transition region 234 may be received by key slot 214 of inner race 213. At least a portion of transition region 234 may be received by key slot 221 of shaft 220. Alternatively, none of transition region 234 may be received by key slot 221 of shaft 220.

Because key 230 has transition region 234, width W_{OR} is different than width W_{IR}. As depicted, width W_{OR} is greater than width W_{IR}. Shafts may have key slots that conform to ANSI standard dimensions. These dimensions include widths and depths of key slots. Different shafts may have different dimensions. At the same time, it may be desirable to avoid customizing a given inner race to match a given shaft. Instead, it may be more expedient and cost effective to use customized keys to couple mismatched key slots in an inner race and a shaft.

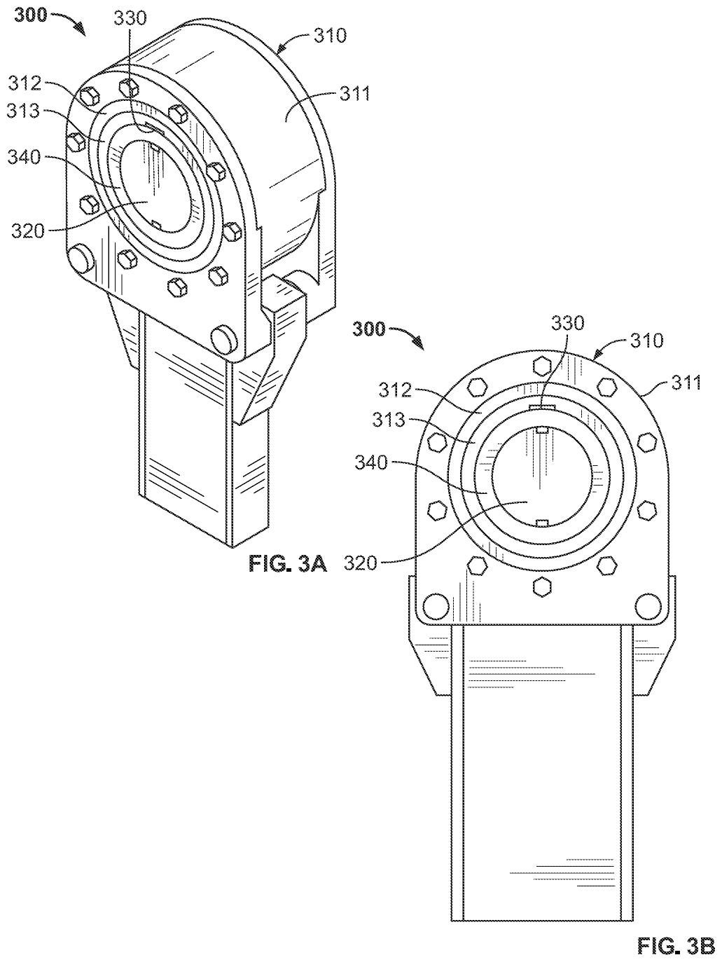

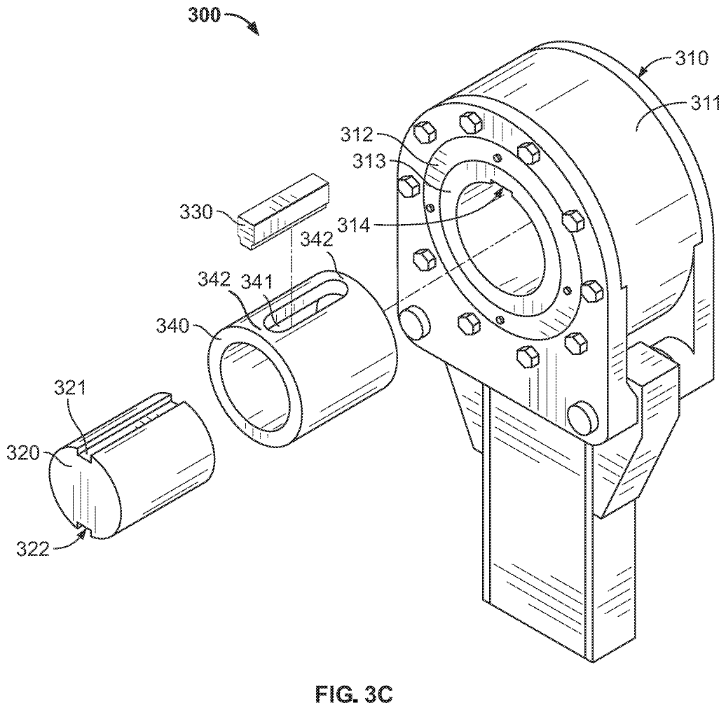

FIGS. 3A-3C show perspective, front, and exploded views, respectively, of a system 300 including clutch 310, shaft 320, key 330, and sleeve 340, according to a second arrangement. Clutch 310 may be similar or identical to clutches 110, 210. Clutch 310 includes outer race 312 and inner race 313, which may be similar or identical to outer races 112, 212 and inner races 113, 213, respectively. Inner race 313 may include key slot 314. Shaft 320 may be similar or identical to shafts 120, 220. Shaft 320 includes key slot 321. Key slot 314 of the inner race 313 and key slot 321 of shaft 320 receive different regions of key 330. Key 330 may be similar or identical to key 230. The effect of clutch 310 on shaft 320 may be similar or identical to that discussed above in context of FIGS. 1A-1C and 2A-2C. Specifically, inner race 313 of clutch 310 may be rotationally coupled to shaft 320 when key 330 is in place.

Sleeve 340 includes key slot 341. As shown key slot 341 does not transverse the entire length of sleeve 340. Instead, one or more bridging portions 342 may extend across the end(s) of key slot 341. Two bridging portions 342 are shown, but one or three or more bridging portions 342 are also considered. Bridging portion(s) 342 may improve the structural integrity of sleeve 340 and may make machining sleeve 340 easier. In other respects, sleeve 340 may be similar or identical to sleeve 240.

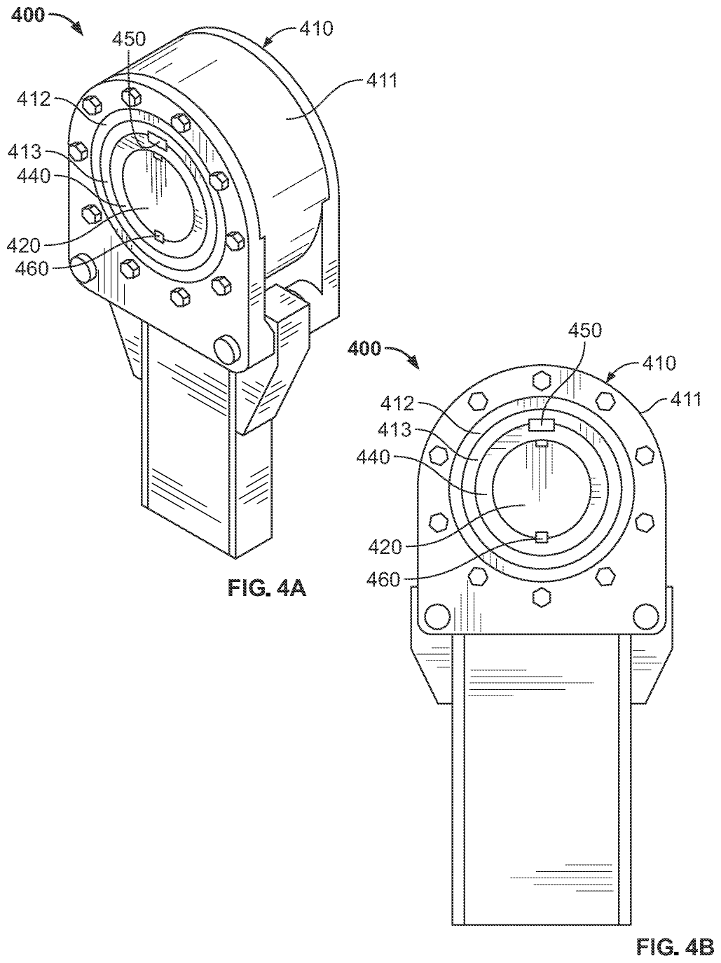

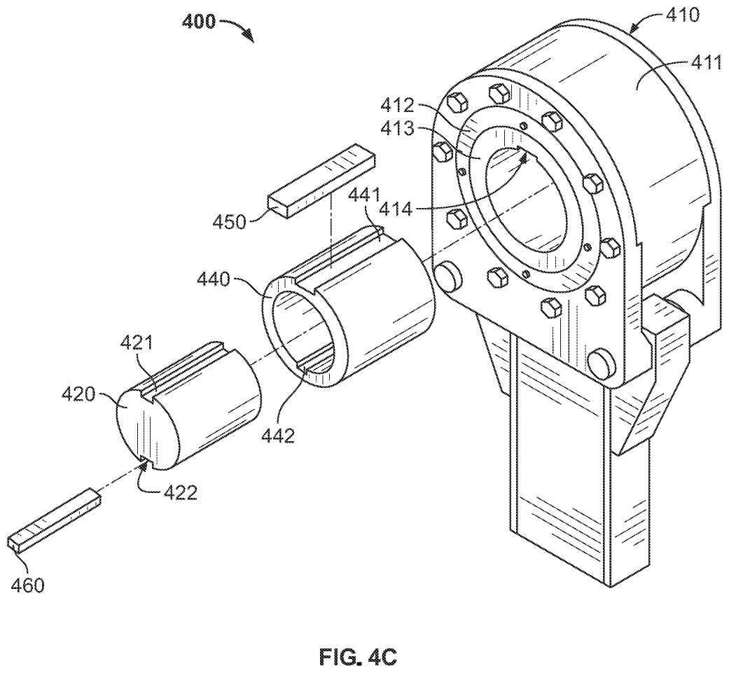

FIGS. 4A-4C show perspective, front, and exploded views, respectively, of a system 400, including clutch 410, shaft 420, sleeve 440, first key 450, and second key 460, according to a third arrangement. Clutch 410 may be similar or identical to clutches 110, 210, 310. Shaft 420 may be similar or identical to shafts 120, 220, 320.

Sleeve 440 may have first key slot 441 and second key slot 442. Inner race 413 of clutch 410 may have key slot 414. First key slot 441 of sleeve 440 may face key slot 414 of inner race 413 (i.e., first key slot 441 is on the outer surface of sleeve 440). As shown, first key slot 441 may not extend through the wall of sleeve 440, although it may be possible for first key slot 441 to extend through the wall of sleeve 440. It may also be possible for first key slot 441 to traverse the length of sleeve 440, or for bridging portions to be present, as with the second arrangement (not shown in FIGS. 4A-4C).

First key 450 may be received by key slot 414 of inner race 413 and first key slot 441 of sleeve 440. First key 450 may be formed of or include a material such as hardened or non-hardened steel. First key slot 441 of sleeve 440 may have an identical or different width and/or depth as key slot 414 of inner race 413. As depicted, first key 450 does not have a transition region (as compared to transition region 234 in key 230). Alternatively, first key 450 may have a transition region if key slot 414 of inner race 413 and first key slot 441 of sleeve 440 have different widths. If a transition region is present in key 450, the transition region may be positioned in a portion of key slot 414 of inner race 413, a portion of first key slot 441 of sleeve 440, or in portions of both key slot 414 and first key slot 441 (i.e., the transition region extends across both key slots 414, 441).

Shaft 420 may have key slot 421 and key slot 422. Second key slot 442 of sleeve 440 may face key slot 422 of shaft 420 (i.e., second key slot 442 is on the inner surface of sleeve 440). As shown, second key slot 442 does not extend through the wall of sleeve 440, although it may be possible for second key slot 442 to extend through the wall of sleeve 440.

Second key 460 may be received by key slot 422 of shaft 420 and second key slot 442 of sleeve 440. Second key 460 may be formed of or include a material such as hardened or non-hardened steel. Second key slot 442 of sleeve 440 may have an identical or different width and/or depth as key slot 422 of shaft 420. As depicted, second key 460 does not have a transition region (as compared to transition region 234 in key 230). Alternatively, second key 460 may have a transition region when key slot 422 of shaft 420 and second key slot 442 of sleeve 440 have different widths. If a transition region is present in second key 460, the transition region may be positioned in a portion of key slot 422 of shaft 420, a portion of second key slot 442 of sleeve 440, or in portions of both of these key slots 422, 442 (i.e., the transition region extends across both key slots 422, 442). Second key slot 442 of sleeve 440 may or may not extend through the wall of sleeve 440. Second key slot 442 of sleeve 440 may have bridging portion(s) (not shown) similar to bridging portion(s) shown in the second arrangement.

As shown, the centerline of first key slot 441 of sleeve 440 and the centerline of second key slot 442 of the sleeve 440 are arranged in line on sleeve 440 (i.e., the centerlines are offset by 180 degrees). It may also be possible to have the centerlines offset by a different amount, such as 90 degrees or 270 degrees.

First key 450 (and/or corresponding first key slot 441 of sleeve 440 and key slot 414 of inner race 413) may be wider than second key 460 (and/or corresponding second key slot 442 of sleeve 440 and key slot 422 of shaft 420). This may be useful because a wider key may receive higher torque.

First key slot 441 or second key slot 442 may not extend through the wall of sleeve 440 (as shown). This may be useful to reduce cost of production and simplify manufacture. It also may be useful to allow for the use of a standard ANSI key.

According to the third arrangement (e.g., FIGS. 4A-4C), inner race 413, sleeve 440, and shaft 420 are rotationally coupled, as with the first arrangement (e.g., FIGS. 2A-2C) and the second arrangement (e.g., FIGS. 3A-3C). First key 450 serves to couple inner race 413 and sleeve 440. Second key 460 serves to couple sleeve 440 and shaft 420.

Based on the concepts disclosed herein, it may be possible to have other arrangements in which one or more keys are used with a sleeve to rotationally couple an inner race with a shaft. For example, it may be possible to have two or more sleeves between an inner race and a shaft. In such arrangement(s), one or more keys may be used to rotationally couple the sleeves with each other (e.g., concentric sleeves would have key slots facing each other that receive a key).

It may also be possible to have key(s) integrated with other elements of the various arrangements. For example, an adaptation of the first arrangement (e.g., FIGS. 2A-2C) may have portion(s) of key 230 integrated with inner race 213 and/or sleeve 240. As another example, an adaptation of the second arrangement (e.g., FIGS. 3A-3C) may have portion(s) of key 330 integrated with inner race 313 and/or sleeve 340. As another example, an adaptation of the third arrangement (e.g., FIGS. 4A-4C) may have portion(s) of first key 450 integrated with inner race 413 and/or sleeve 440. Additionally, second key 460 may be integrated with sleeve 440.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A key for use in a system with a shaft, a clutch, and a sleeve, wherein the shaft has a shaft key slot, wherein the clutch includes a rotating clutch portion having a rotating clutch portion key slot, wherein the sleeve has as sleeve key slot, and wherein the key comprises:
an elongated body including an outer region, an inner region, and a transition region between the outer region and the inner region,
wherein the outer region comprises a width and is sized to be received by the sleeve key slot,
wherein the inner region comprises a width and is sized to be received by the shaft key slot such that the sleeve and the shaft are rotationally coupled with each other, wherein the width of the inner region is smaller than the width of the outer region, and
wherein the transition region includes a varying width such that a width of a portion of the transition region proximate the outer region is greater than a width of a portion of the transition region proximate the inner region.

2. The key of claim 1, wherein the outer region of the key is further configured to be received by the rotating clutch portion key slot, such that the shaft, the rotating clutch portion, and the sleeve are rotationally coupled to each other

3. The key of claim 1, wherein the varying width of the transition region of the key is defined at least in part by a radius.

4. The key of claim 3, wherein the radius is between approximately 0.016″ and 0.2″.

5. The key of claim 3, wherein the varying width of the transition region of the key is defined at least in part by a first radius on a first side and a second radius on a second side.

6. The key of claim 5, wherein the first radius is between approximately 0.016″ and 0.2″, and wherein the second radius is between approximately 0.016″ and 0.2″.

7. The key of claim 1, wherein the key comprises non-hardened steel.

8. A coupling system for coupling a rotating clutch portion of a clutch with a shaft, wherein the rotating clutch portion has a rotating clutch portion key slot, wherein the shaft has a shaft key slot, and wherein the coupling system comprises:
a sleeve having a wall and a sleeve key slot through the wall, wherein the sleeve is configured to be received by the rotating clutch portion, and wherein the sleeve is configured to receive the shaft; and
a key having a height, wherein the key includes an outer region, an inner region, and a transition region between the outer region and the inner region, wherein the outer region comprises a width and is sized to be received by the rotating clutch portion key slot, wherein the inner region comprises a width and is sized to be received by the shaft key slot, wherein the width of the inner region is smaller than the width of the outer region, and wherein the transition region includes a varying width such that a width of a portion of the transition region proximate the outer region is greater than a width of a portion of the transition region proximate the inner region,
wherein the key is configured to be simultaneously received by the shaft key slot, the sleeve key slot, and the rotating clutch portion key slot such that the shaft and the sleeve are rotationally coupled.

9. The coupling system of claim 8, wherein a portion of the outer region of the key is configured to be received by the shaft key slot.

10. The coupling system of claim 8, wherein the transition region of the key is not configured to be received by the shaft key slot.

11. The coupling system of claim 10, wherein the transition region of the key is configured to only be received by the sleeve key slot.

12. The coupling system of claim 8, wherein the length of the key and the length of the sleeve are approximately the same.

13. The coupling system of claim 8, wherein the varying width of the transition region of the key is defined at least in part by a first radius on a first side and a second radius on a second side, wherein the first radius is between approximately 0.016″ and 0.2″, and wherein the second radius is between approximately 0.016″ and 0.2″.

14. The coupling system of claim 8, wherein the sleeve key slot only extends across a portion of the length of the sleeve.

15. The coupling system of claim of claim 17, wherein the sleeve key slot does not extend to either end of the sleeve.

16. The coupling system of claim 8, further comprising a second key, wherein the sleeve has a second sleeve key slot, and wherein the second key is configured to be received by the rotating clutch portion key slot and the second sleeve key slot such that the sleeve and the rotating clutch portion are rotationally coupled to each other.

17. The coupling system of claim 16, wherein the sleeve key slot does not extend through the thickness of the sleeve, and wherein the second sleeve key slot does not extend through the thickness of the sleeve.

18. A coupling system for coupling a rotating clutch portion of a clutch with a shaft, wherein the rotating clutch portion has a rotating clutch portion key slot, wherein the shaft has a shaft key slot, and wherein the coupling system comprises:
a sleeve including a wall having an outer surface and an inner surface, wherein the sleeve includes a first key slot in the outer surface of the wall, wherein the sleeve includes a second key slot in the inner surface of the wall, wherein the sleeve is configured to be received by the rotating clutch portion, and wherein the sleeve is configured to receive the shaft;
a first key configured to be received by the rotating clutch portion key slot and the first key slot of the sleeve, such that the rotating clutch portion and the sleeve are rotationally coupled; and
a second key configured to be received by the shaft key slot and the second key slot of the sleeve, such that the shaft and the sleeve are rotationally coupled.

19. The coupling system of claim 18, wherein the first key is wider than the second key, and wherein the first key slot of the sleeve is wider than the second key slot of the sleeve.

20. The coupling system of claim 18, wherein the first key slot of the sleeve defines a first centerline, wherein the second key slot of the sleeve defines a second centerline, and wherein the first centerline and the second centerline are offset by 180 degrees around the sleeve.
